(19) United States
(12) Patent Application Publication
(10) Pub. No.: US 2009/0107042 A1
(43) Pub. Date: Apr. 30, 2009

(54) Wall mountable planters

(75) Inventor: Brendon Nunes, Ajax (CA)

Correspondence Address: ROBERT A. VANDERHYE, 801 RIDGE DR., MCLEAN, VA, 22101-1625, US

(73) Assignee: Trintec Industries, Inc.

(21) Appl. No.: 11/976,467

(22) Filed: Oct. 25, 2007

(51) Int. Cl. A01G 9/02

(52) U.S. Cl. 47/83; 47/65.5

(57) ABSTRACT

An at least partially open top container desirably functions as a planter and provides for effective yet aesthetic mounting of a number of like containers in a vertical array. The planter includes a hollow body having at least partially closed sides and bottom, including a back side. First surface manifestations, such as a pair of recessed keyhole-shaped openings, are associated with the back side to facilitate mounting to a wall. Second surface manifestations, such as a pair of recessed projections, are also associated with the back side to facilitate mounting to keyhole openings in another similar planter in a vertical array, interlocking the planters together. The planter may contain potting material and real or artificial plants, and a number of interlocked planters are typically provided in combination in a vertical array.

### BACKGROUND AND SUMMARY OF THE INVENTION

In many situations it is highly desirable to provide planters, or other containers, in a substantially vertical array, both for practical and aesthetic reasons. For example, primarily functional substantially vertical arrays of planters are illustrated in U.S. Pat. Nos. 875,235, 4,295,296, 4,779,378, and 7,043,877, while primarily ornamental arrays are illustrated in U.S. Pat. Nos. D 290,564, D 407,994, and D 493,384. According to the present invention it is possible to provide planters, and other containers, readily mountable on walls (or like substantially vertical surfaces) in vertical arrays for both aesthetic and functional reasons.

According to the invention it is possible to provide a vertical array of planters or like containers by mounting only the topmost planter to a wall. The other planters in the array interlock with the topmost planter so that they are securely mounted, yet they can be readily removed from the array (not requiring their own separate mounting structures). The planters inherently provide an aesthetic effect, much like a cascading fountain or waterfall, and allow a readily variable amount of wall area to be covered depending upon particular aesthetic needs. The planters typically contain potting material and real or artificial plants. The plants can be varied to provide a desired amount of functional wall covering, or to provide a desired aesthetic effect. The plants within the array are readily accessible for watering, feeding, and pruning, without disassembly of the array. Any number of planters may be provided in the vertical array.

According to one aspect of the present invention, there is provided an at least partially open top container comprising: A substantially hollow body having at least partially closed sides and bottom, and at least a partially open top, the sides including a back side. First surface manifestations associated with (e.g. formed in) the back side which facilitate mounting the container to a generally vertical surface; and second surface manifestations associated with (e.g. extending from) the back side which facilitate mounting of the container to first surface manifestations in another similar container.

Preferably the container back side includes a first portion which is substantially planar and will abut a generally vertical surface (e.g. wall) when the container is mounted by the first surface manifestations to the wall; and a second portion which is recessed with respect to the first portion. The second portion contains the first and second surface manifestations so that none of the surface manifestations engage a wall on which the container is mounted. Also, preferably the second portion of the back side is substantially horizontally centrally located in the back side. Also, most desirably the second portion of the back side includes an upper portion containing the first surface manifestations, and a lower portion containing the second surface manifestations, the lower portion recessed a larger amount from the first portion than the upper portion is recessed from the first portion.

The first surface manifestations may comprise at least one substantially key-shaped opening in the back side which can receive wall mounting hardware, and the second surface manifestations may include at least one interlocking projection dimensioned to fit within the substantially key-shaped opening of a vertically below similar container so that the containers interlock. While a plurality of each of the manifestations may be provided, desirably for most usefully sized containers and associated walls, the first surface manifestations comprise exactly two substantially key-shaped openings, and the second surface manifestations comprise exactly two interlocking projections.

While the container may be used for many different purposes, in a preferred embodiment the sides and bottom are substantially closed, so that the container may effectively contain potting material and real or artificial plants. For example, the container may comprise a planter in combination with potting material and real plant life therein.

The planter may comprise a first planter, and be provided in combination with at least one other vertically spaced similar second planter, the second surface manifestations of the first planter operatively engaging the first surface manifestations of the second planter. Desirably, the bottom of each planter is less than one half the area of the top thereof, and the top is substantially completely open, so that when planter are in combination in a substantially vertical array, the bottom of an upper planter does not interfere significantly with the substantially open top of a lower planter. This makes it easy to water, fertilize, and prune the plants in all of the planters without disassembly of the vertical array.

According to another aspect of the present invention a planter is provided comprising: A substantially hollow body including a substantially closed bottom, a substantially open top, and substantially closed sides including a back side. First and second openings in the back side adjacent the substantially open top; and first and second interlocking projections extending outwardly from the back side for cooperating with openings like the first and second openings in a similar planter, the projections between the bottom and the openings. The planter desirably contains potting material and real or artificial plants. Also, the openings and interlocking projections are all preferably in a recessed portion of the back side. In this way when the planter is a first planter in combination with a second substantially functionally identical planter, in a vertical array, the first planter is mounted by the first and second openings (which receive mounting hardware therein) on a substantially vertical surface (wall), and the second planter first and second openings receive the first and second projections from the first planter, and the projections are sufficiently recessed in the back sides so that the projections do not engage the wall.

The invention also relates to the ornamental design for a wall mountable planter according to FIGS. 6-10, as shown and described.

It is the primary object of the present invention to provide both a functional and aesthetic planter or like container that may be quickly and easily mounted with similar planters in a vertical array. This and other objects of the invention will become clear from the detailed description of the invention, and from the appended claims.

### BRIEF DESCRIPTION OF THE DRAWINGS

FIG. 1 is a top perspective view of one embodiment of an exemplary planter/container according to the invention;

FIG. 2 is a rear bottom perspective view of the planter of FIG. 1;

FIG. 3 is a side view, partly in cross-section and partly in elevation, of the planter of FIGS. 1 & 2 mounted to a wall and in combination with potting material and live plants, with another substantially identical planter shown in dotted line in a vertical array therewith;

FIG. 4 is a top perspective view of an ornamentally different, but functionally the same, planter like that of FIGS. 1-3 shown in a vertical array with another functionally identical planter;

FIG. 5 is a rear/back view of the array of FIG. 4;

FIG. 6 is a top perspective view of an ornamental design for a wall mountable planter;

FIG. 7 is a bottom rear perspective view of the planter of FIG. 6;

FIG. 8 is a top view of the planter of FIG. 6;

FIG. 9 is a bottom view of the planter of FIG. 6; and

FIG. 10 is an end/side view of the planter of FIG. 6.

### DETAILED DESCRIPTION OF THE DRAWINGS

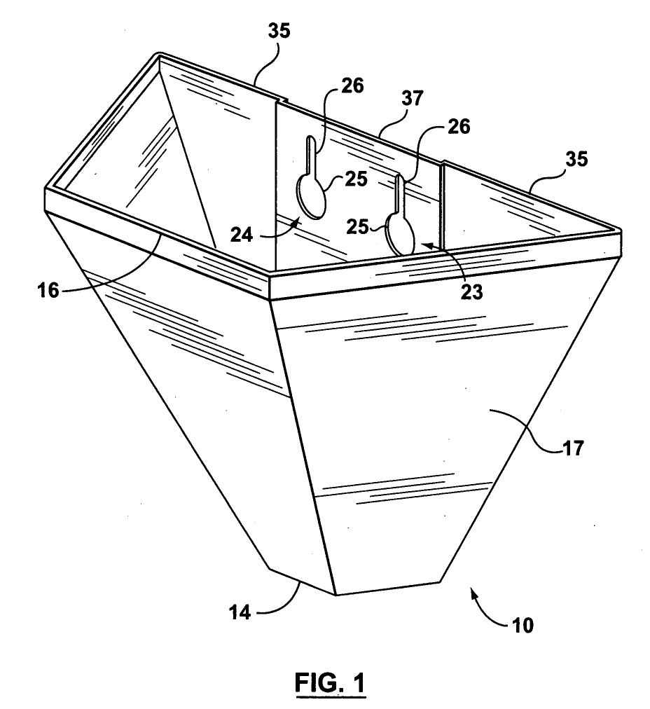

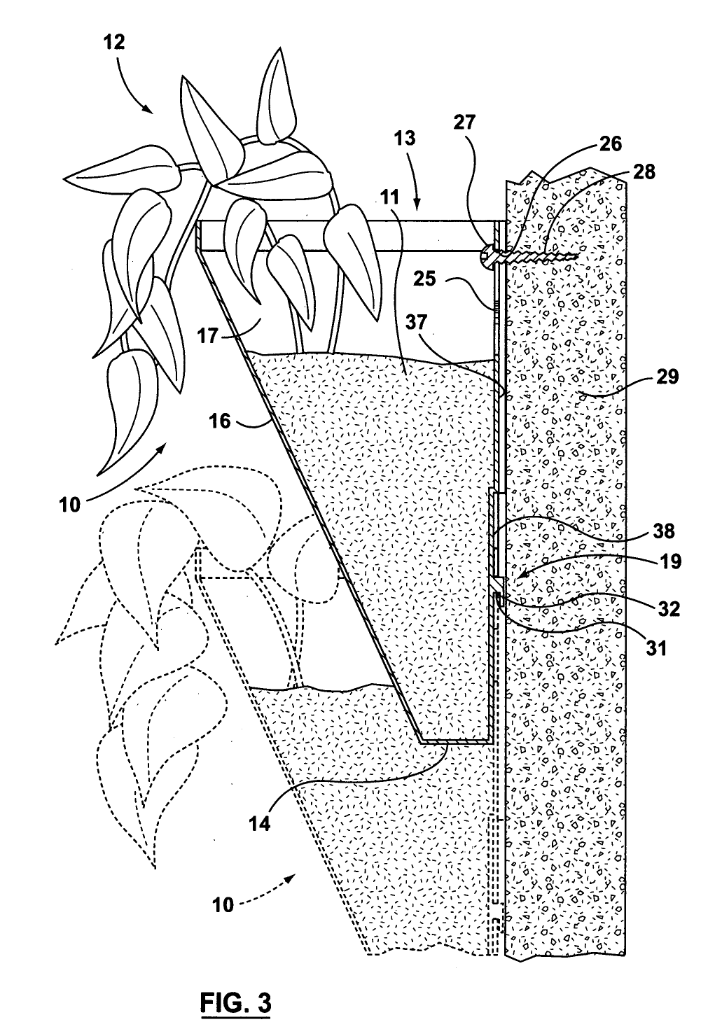

FIG. 1 illustrates an exemplary container 10 according to the invention. The container 10 may be specially designed to perform a number of different functions, such as holding fasteners of different types, food items, toys, or a wide variety of other objects. The items may be supported by the container 10 in order to make them easy to access, for display at a point-of-purchase location, or simply to segregate different items. While the container 10 may perform many functions, according to the preferred embodiment of the invention, the container 10 functions as a planter, desirably containing potting material 11 and live or artificial plants 12 (see FIG. 3). The container 10 will hereafter be referred to interchangeably as a container or planter.

The planter 10 comprises a substantially hollow body having at least partially closed sides and bottom, and at least a partially open top shown generally by reference numeral 13 in FIGS. 1-3. The bottom 14 is preferably substantially completely closed (so that it can contain granular material, such as potting material like dirt, sand, vermiculite, compost, and combinations thereof), and typically has an area significantly less than the area of the open top 13 (preferably less than one-half the area, e.g. about 10-20% of the area) so that the plants 12 in a lower planter 10 can be easily accessed in a vertical array of planters 10.

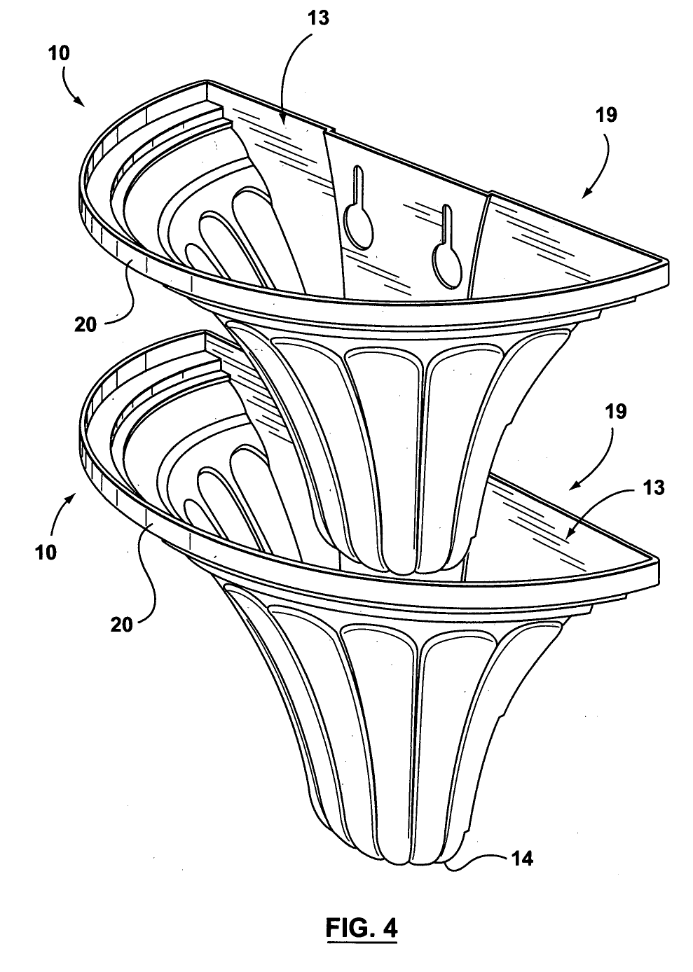

The sides of the planter 10 will be shaped and dimensioned depending upon the shape of the planter 10 desired for functional and/or aesthetic reasons. In the embodiment illustrated in FIGS. 1-3, the planter 10 has a front side 16, left and right sides 17 and 18 respectively, and a back side 19. However for other configurations (e.g. see FIGS. 4 & 5), the planter may simply have a back side 19 and a continuously curved front side 20. Many other shapes are also possible.

Associated with the back side 19, as clearly seen in FIGS. 1-3, are first surface manifestations 21 adjacent the open top 13, and second surface manifestations 22 between the manifestations 21 and the bottom 14. The first manifestations 21 are—in the preferred embodiment illustrated—a pair of substantially keyhole-shaped openings 23, 24, each having a large bottom portion 25, and a smaller top portion 26. The manifestations 21 facilitate the mounting of the planter on a generally vertical surface, e.g. a wall 29. For example, the openings 23, 24 may each receive a fastener—such as the screw 28 illustrated in FIG. 3—which operatively engages the wall 29 and extends through the smaller top portion 26 of an opening 23, 24, to mount the planter 10 to the wall 29. Head 27 of screw 28 cannot pass through 26. While exactly two openings 23, 24 are preferred, under some circumstances a single opening, or three or more openings, may be provided as the manifestations 21.

The second manifestations 22—in the preferred embodiment illustrated—comprise a pair of interlocking projections 30. However, as with the openings 23, 24, any number may be provided.

The projections 30 may have a wide variety of shapes, but typically include a relatively small cross-section shaft section 31 (FIG. 3), and a relatively large cross-section free end portion 32 of almost any configuration. The shaft section 31 is operatively connected to (e.g. integral with) the back side 19. The shaft section 31 is dimensioned to fit (without too much play) in the smaller top portion 26 of an opening 23, 24, however the free end portion 32 is significantly larger than the width of the smaller top portion 25 and cannot pass through it. However, the free end portion 32 has a smaller area than the larger bottom portion 25 of an opening 23, 24, and can fit through it. Thus, as illustrated in FIGS. 3 & 5, the free ends 32 of the projections 30 of an upper planter 10 are passed through the opening portions 25 of a lower planter 10, and then the planters 10 are displaced vertically with respect to each other, so that the shaft sections 31 of the projections 30 of the upper planter 10 are received by the smaller top portions 26 of the openings 23, 24 of the lower planter, removably interlocking the two planters 10 together.

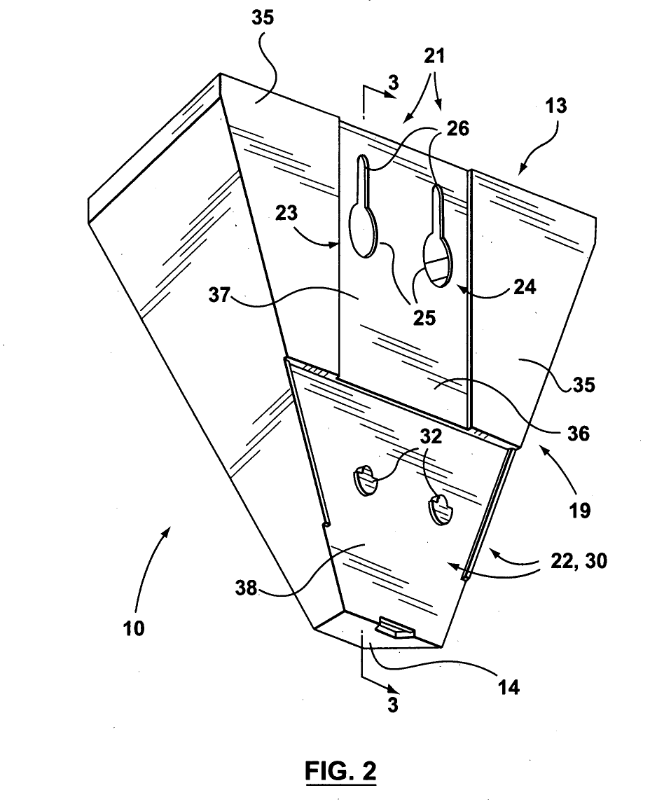

In the preferred embodiment, the planter 10 is constructed so that the projections 30 do not engage a wall 29 on which the planter 10 is mounted, since the projections 30 could damage the wall. This is desirably done by constructing the back side 19 so that it has a first portion 35 which is substantially planar and may (or will) abut a wall 29 (as seen in FIG. 3), and a second recessed portion 36 containing the first and second surface manifestations 21, 22. As clearly seen in FIG. 2, the second portion 36 is desirably substantially horizontally centrally located in the back side 19 and straddled by parts of first portion 35.

The second portion 36 preferably includes an upper portion 37 containing the first surface manifestations 21, and a lower portion 38 containing the second surface manifestations 22. As seen in FIGS. 2 & 3, the lower portion 38 is recessed a larger amount from the first portion 35 than is the upper portion 37. In this way, the free ends 32 of the projections 30 will not engage the wall 29 (as seen in FIG. 3) during normal use of the container 10, yet the manifestations 21, 22, may easily be moved into and out of interlocking relationship.

FIGS. 3-5 show two containers 10 mounted in a vertical array. The containers 10 of FIGS. 4 & 5 are functionally the same as the containers 10 of FIGS. 1-3, differing only in their ornamental features. Any number of containers 10 may be mounted in the vertical array.

The containers 10 may be made of a wide variety of materials, depending upon their exact function, ease of manufacture, and aesthetic effects, desired. For example, the containers 10 may be made out of molded metal or plastic. Or they may be cast from ceramic, cement, or like materials. Or they may be made from stamped pieces of metal that are welded together, and/or joined adhesively. Some exemplary (only) metals that could be used are bronze, copper, brass, aluminum, and steel. Almost any moldable plastic, or like material, may alternatively be used, or some portions of the containers 10 may be made of one material, and other parts of another.

While a preferred embodiment of the invention is illustrated and described, of course many modifications may readily be made within the scope of the invention. For example, a number of other sets of surface manifestations besides the two sets 21, 22 illustrated, may be provided; the surface manifestations may be horizontally oriented tabs and slots (or virtually any other type of conventional surface manifestation) instead of openings and projections; where provided the projections 30 may be welded or adhesively connected, or connected by fasteners, to the back side 19; which manifestations are male and which are female may be switched; and/or all of the surface manifestations may comprise hook and loop fasteners with the first surface manifestations mounted to cooperating hook or loop fasteners on the wall 29. Additional functional devices, such as watering tubes (see U.S. Pat. No. 4,295,296), may also be provided.

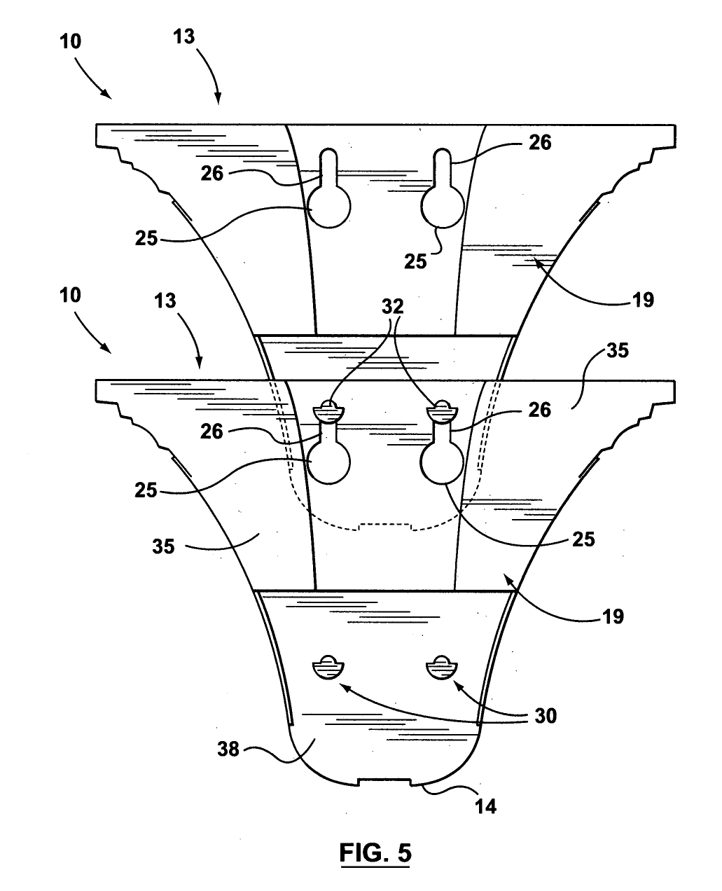

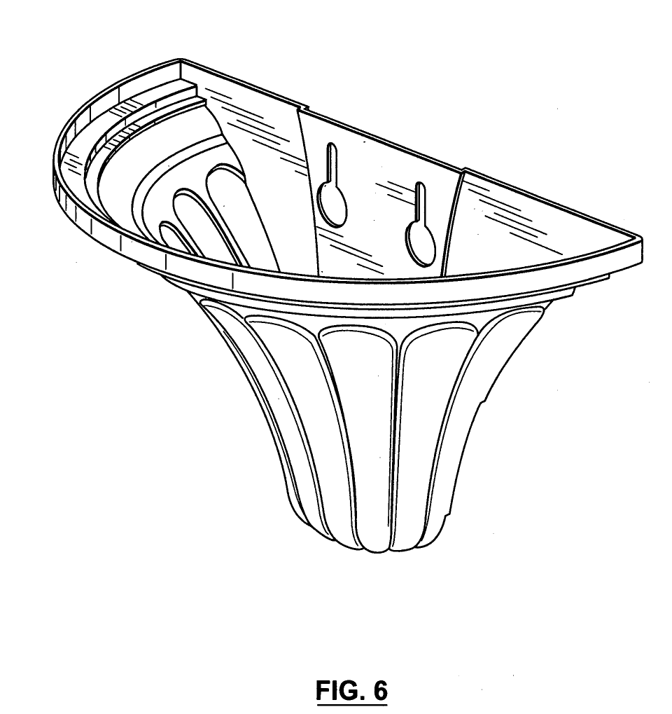

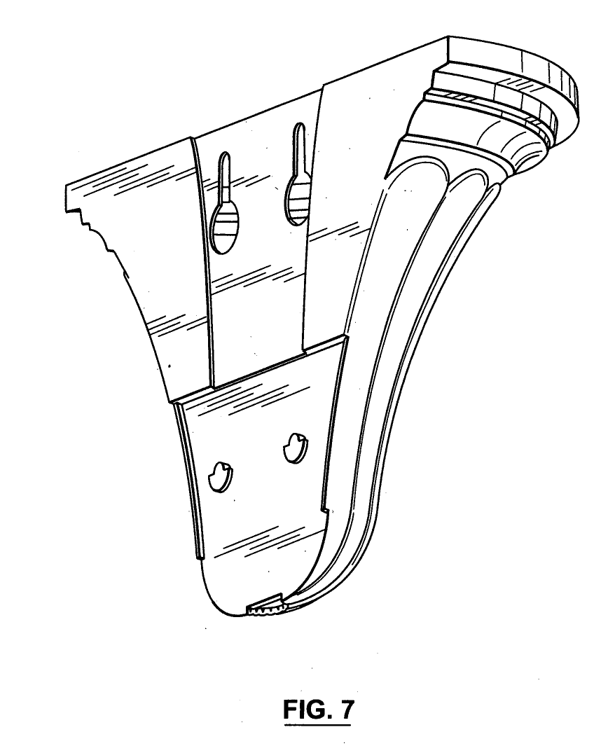

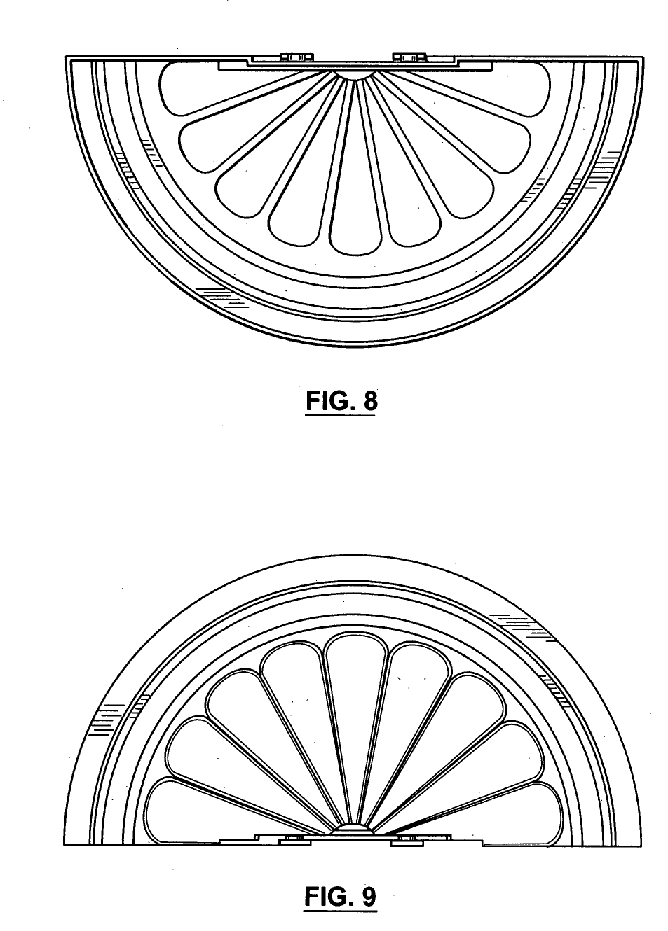

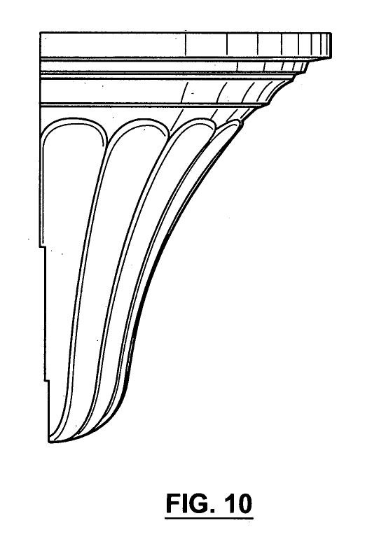

FIGS. 6-10 are illustrations of an ornamental version of a wall mountable planter according to the invention which is particularly aesthetic. The planter of FIGS. 6-10 has the same basic configuration as the planters 10 of FIGS. 4 and 5.

While the invention has been herein shown and described in what is presently conceived to be the preferred embodiment thereof, it will be apparent to those in the art that many modifications may be made within the scope of the invention. Therefore the appended claims are to be given the broadest interpretation possible so as to encompass all equivalent structures and devices.

1. An at least partially open top container comprising:
a substantially hollow body having at least partially closed sides and bottom, and at least a partially open top, said sides including a back side;
first surface manifestations associated with said back side which facilitate mounting the container to a generally vertical surface; and
second surface manifestations associated with said back side which facilitate mounting the container to first surface manifestations in another similar container.

2. A container as recited in claim 1 wherein said back side includes a first portion which is substantially planar and may abut a generally vertical surface when said container is mounted by said first surface manifestations to the generally vertical surface; and a second portion which is recessed with respect to said first portion, said second portion containing said first and second surface manifestations so that none of said surface manifestations engage a generally vertical surface on which said container is mounted.

3. A container as recited in claim 2 wherein said second portion of said back side is substantially horizontally centrally located in said back side.

4. A container as recited in claim 2 wherein said second portion of said back side includes an upper portion containing said first surface manifestations, and a lower portion containing said second surface manifestations, said lower portion recessed a larger amount from said first portion than said upper portion is recessed from said first portion.

5. A container as recited in claim 4 wherein said first surface manifestations comprise at least one substantially key-shaped opening in said back side which can receive wall mounting hardware; and wherein said second surface manifestations include at least one interlocking projection dimensioned to fit within said substantially key-shaped opening of a vertically below similar container to interlock therewith.

6. A container as recited in claim 4 wherein said first surface manifestations comprise exactly two substantially key-shaped openings, and wherein said second surface manifestations comprise exactly two interlocking projections.

7. A container as recited in claim 6 wherein said second portion of said back side is substantially horizontally centrally located in said back side.

8. A container as recited in claim 1 wherein said first surface manifestations comprise at least one substantially key-shaped opening in said back side which can receive wall mounting hardware; and wherein said second surface manifestations include at least one interlocking projection dimensioned to fit within said substantially key-shaped opening of a vertically below similar container to interlock therewith.

9. A container as recited in claim 8 wherein said first surface manifestations comprise exactly two substantially key-shaped openings, and wherein said second surface manifestations comprise exactly two interlocking projections.

10. A container as recited in claim 1 wherein said sides and bottom are substantially closed, so that said container may effectively contain potting material and real or artificial plants.

11. A container as recited in claim 1 wherein said container comprises a planter in combination with potting material and real plant life therein.

12. A planter as recited in claim 11 comprising a first planter, and in combination with at least one other vertically spaced functionally similar second planter, the second surface manifestations of the first planter operatively engaging the first surface manifestations of said second planter.

13. A combination of planters are recited in claim 12 wherein for each of said planters said first surface manifestations comprise at least one substantially key-shaped opening in said back side which can receive wall mounting hardware; and said second surface manifestations include at least one interlocking projection dimensioned to fit within said substantially key-shaped opening of a cooperating planter.

14. A combination of planters as recited in claim 13 wherein said first surface manifestations for each planter comprise exactly two substantially key-shaped openings, and wherein said second surface manifestations for each planter comprise exactly two interlocking projections.

15. A planter as recited in claim 11 wherein said bottom of said planter is less than one half the area of said top thereof, and said top is substantially completely open, so that if said planter is in combination with other planters in a vertical array, the bottom of an upper planter does not interfere significantly with the substantially open top of a lower planter.

16. A combination of planters as recited in claim 12 wherein said bottom of said each of said first and second planters is less than one half the area of said top thereof, and said top is substantially completely open, so that the bottom of said first planter does not interfere significantly with the substantially open top of said second planter.

17. A planter comprising:
a substantially hollow body including a substantially closed bottom, a substantially open top, and substantially closed sides including a back side;
first and second openings in said back side adjacent said substantially open top; and
first and second interlocking projections extending outwardly from said back side for cooperating with openings like said first and second openings in a similar planter, said projections between said bottom and said openings.

18. A planter as recited in claim 17 containing potting material and real or artificial plants.

19. A planter as recited in claim 18 wherein said first and second openings and said first and second interlocking projections are in a recessed portion of said back side; and wherein said planter is a first planter in combination with a second functionally identical planter in a vertical array; and
wherein said first planter is mounted by said first and second openings therein on a substantially vertical surface, and said second planter first and second openings receive said first and second projections from said first planter; and
wherein said projections are sufficiently recessed in said back sides so that said projections do not engage said substantially vertical surface.

20. The ornamental design for a wall mountable planter according to FIGS. 6-10, as shown and described.
